(19) United States
(12) Patent Application Publication
(10) Pub. No.: US 2018/0062777 A1
(43) Pub. Date: Mar. 1, 2018

(54) TRANSMISSION DEVICE, TRANSMISSION METHOD, RECEPTION DEVICE, AND RECEPTION METHOD

(71) Applicant: SONY CORPORATION, Tokyo (JP)

(72) Inventors: Taketoshi YAMANE, Tokyo (JP); Yasuaki YAMAGISHI, Kanagawa (JP)

(73) Assignee: SONY CORPORATION, Tokyo (JP)

(21) Appl. No.: 15/557,481

(22) PCT Filed: Mar. 28, 2016
(86) PCT No.: PCT/JP2016/001777

§ 371 Date: Sep. 12, 2017

(30) Foreign Application Priority Data
Apr. 8, 2015 (JP) 2015-079603

(51) Int. Cl. H04H 20/59; H04W 4/22; H04W 4/06; G10L 13/10; G10L 13/033; H04N 21/45

(52) U.S. Cl. CPC H04H 20/59; H04W 4/22; H04W 4/06; G10L 2013/083; G10L 13/033; H04N 21/4532; H04M 2201/39; G10L 13/10

(57) ABSTRACT

There is provided a transmission device, including circuitry configured to receive alert information including metadata related to a predetermined pronunciation of a message. The circuitry is configured to generate vocal information for the message based on the metadata included in the alert information. The circuitry is further configured to transmit emergency information that includes the message and the generated vocal information for the message.

### TECHNICAL FIELD

The present technology relates to a transmission device, a transmission method, a reception device, and a reception method, and more particularly to, a transmission device, a transmission method, a reception device, and a reception method, which are capable of improving accessibility for the visually handicapped.

### CROSS REFERENCE TO RELATED APPLICATIONS

This application claims the benefit of Japanese Priority Patent Application JP 2015-079603 filed Apr. 8, 2015, the entire contents of which are incorporated herein by reference.

### BACKGROUND ART

In the digital broadcasting field, there is a demand for accessibility for the visually handicapped (for example, see PTL 1).

Particularly, in the USA, the 21st Century Communications and Video Accessibility Act of 2010 (CVAA) has been established, and various regulations related to accessibility of video programs based on this act have been published by the Federal Communications Commission (FCC).

### CITATION LIST

### Patent Literature

PTL 1: JP 2009-204711A

### SUMMARY OF INVENTION

### Technical Problem

Meanwhile, in the USA, an emergency notification system known as the Emergency Alert System (EAS) has established, and this enables notification of various levels of emergency information ranging from top priority matters from the president to local notifications through various media.

In digital broadcasting, even when such emergency information is notified of, despite the demand for accessibility for the visually handicapped, existing text to speech (TTS) engines do not guarantee that the visually handicapped will be able to obtain the same information as others because text information may not be read out loud according to the intentions of an emergency information producer. For this reason, there has been a demand for techniques that allow the visually handicapped to obtain the same information as others by reliably producing utterances as intended by an emergency information producer.

The present technology was made in light of the foregoing, and it is desirable to improve accessibility for the visually handicapped by reliably producing utterances as intended by an emergency information producer.

### Solution to Problem

According to a first embodiment of the present technology, there is provided a transmission device, including circuitry configured to receive alert information including metadata related to a predetermined pronunciation of a message. The circuitry is configured to generate vocal information for the message based on the metadata included in the alert information. The circuitry is further configured to transmit emergency information that includes the message and the generated vocal information for the message.

The transmission device according to a first embodiment of the present technology may be an independent device or an internal block configuring one device. A transmission method according to the first embodiment of the present technology is a transmission method corresponding to the transmission device according to the first embodiment of the present technology. For example, a method of a transmission device for transmitting emergency information includes acquiring, by circuitry of the transmission device, alert information including metadata related to a predetermined pronunciation of a message. The method includes generating, by the circuitry of the transmission device, vocal information for the message based on the metadata included in the alert information. The method further includes transmitting, by the circuitry of the transmission device, the emergency information that includes the message and the generated vocal information for the message.

In a transmission device and a transmission method according to the first embodiment of the present technology, alert information including metadata related to a predetermined pronunciation of a message is received, vocal information for the message is generated based on the metadata included in the alert information, and emergency information that includes the message and the generated vocal information for the message is transmitted.

According to a second embodiment of the present technology, there is provided a reception device, including circuitry configured to receive emergency information including a message and vocal information for the message. The emergency information is transmitted from a transmission device. The circuitry is further configured to output the message for display and output a sound according to a predetermined pronunciation of the message based on the vocal information for the message.

The reception device according to the second embodiment of the present technology may be an independent device or an internal block configuring one device. A reception method according to the second embodiment of the present technology is a reception method corresponding to the reception device according to the second embodiment of the present technology. For example, a method of a reception device for processing emergency information includes receiving, by circuitry of the reception device, emergency information including a message and vocal information for the message. The emergency information is transmitted from a transmission device. The method includes outputting, by the circuitry of the reception device, the message for display. The method further includes outputting, by the circuitry of the reception device, a sound according to a predetermined pronunciation of the message based on the vocal information for the message.

In a reception device and a reception method according to the second embodiment of the present technology, emergency information including a message and vocal information for the message is received, the emergency information being transmitted from a transmission device, the message is output for display, and a sound according to a predetermined pronunciation of the message based on the vocal information for the message is output.

### Advantageous Effects of Invention

According to the first and second embodiments of the present technology, it is possible to improve accessibility for the visually handicapped.

The effect described herein is not necessarily limited and may include any effect described in the present disclosure.

### BRIEF DESCRIPTION OF DRAWINGS

FIG. 1 is a diagram illustrating an overview of transmission of emergency information.

FIG. 2 is a diagram illustrating display examples of emergency information.

FIG. 3 is a diagram for describing an example of a TTS engine of a related art reading text information out loud.

FIG. 4 is a diagram for describing an example of a TTS engine of a related art reading text information out loud.

FIG. 5 is a diagram for describing an example of a TTS engine to which an embodiment of the present technology is applied reading text information out loud.

FIG. 6 is a diagram for describing an example of a TTS engine to which an embodiment of the present technology is applied reading text information out loud.

FIG. 7 is a diagram illustrating a configuration example of a broadcasting system to which an embodiment of the present technology is applied.

FIG. 8 is a diagram illustrating a configuration example of a transmission device to which an embodiment of the present technology is applied.

FIG. 9 is a diagram illustrating a configuration example of a reception device to which an embodiment of the present technology is applied.

FIG. 10 is a diagram illustrating an example of a structure of CAP information.

FIG. 11 is a diagram illustrating a description example of CAP information (an excerpt from Common Alerting Protocol Version 1.201 July, 2010, Appendix A).

FIG. 12 is a diagram illustrating an example of an element and an attribute added by extended CAP information.

FIG. 13 is a diagram illustrating a description example of an XML schema of extended CAP information.

FIG. 14 is a diagram for describing designation of name space in extended CAP information.

FIG. 15 is a diagram illustrating a description example of extended CAP information.

FIG. 16 is a flowchart for describing a transmission process.

FIG. 17 is a flowchart for describing a reception process.

FIG. 18 is a diagram illustrating a configuration example of a computer.

### DESCRIPTION OF EMBODIMENTS

Hereinafter, embodiments of the present technology will be described with reference to the appended drawings. The description will proceed in the following order.

1. Overview of vocal utterance metadata of present technology

2. Configuration of system

3. Arrangement of vocal utterance metadata by extension of CAP information

4. Flow of process executed by devices

5. Modified example

6. Configuration of computer

### 1. Overview of Vocal Utterance Metadata of Present Technology

In the regulations of the FCC related to the CVAA, broadcasters (service providers) are obligated to transmit emergency information (emergency alerts) as vocal information separately from text information such as messages in order to allow the visually handicapped to access the information.

In the regulations of the FCC, the use of TTS engines is recognized as a method of generating the emergency information as vocal information, but clarity and correct pronunciation in the sounds generated by the TTS engines are demanded. Here, a TTS engine is a text to speech synthesizer which is capable of artificially producing a human voice from text information.

Meanwhile, emergency information is transmitted to broadcasting stations as emergency notification information (hereinafter, also referred to as “CAP information”) of a common alerting protocol (CAP) scheme. In other words, in the USA, since the establishment of the emergency notification system known as the EAS, various levels of emergency information (CAP information) ranging from top priority matters from the president to local notifications have been notified of through various media using the EAS.

The CAP information is information that is compliant with the CAP specified by Organization for the Advancement of Structured Information Standards (OASIS).

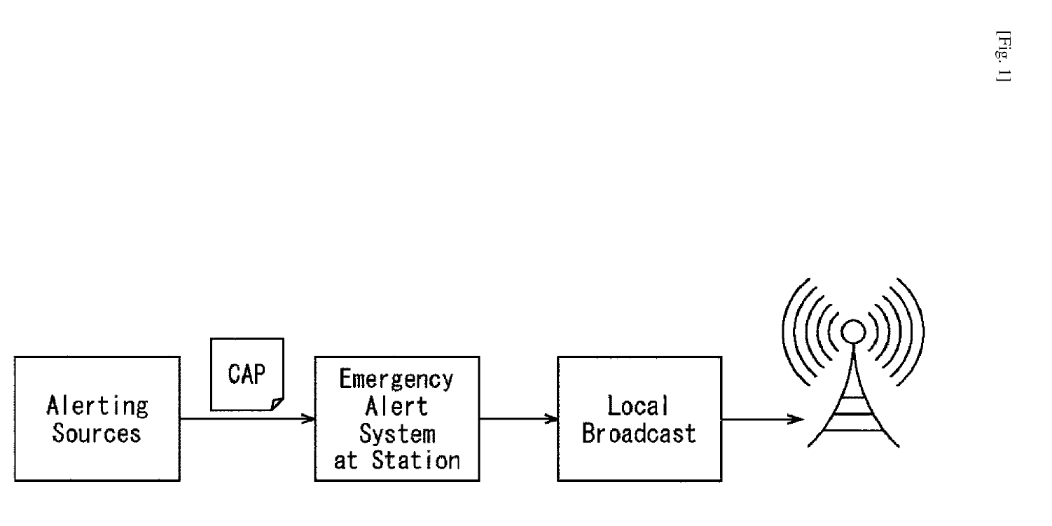

For example, referring to FIG. 1, alerting source information reported by alerting sources (Alerting Sources) is converted into CAP information, and the CAP information is provided to (an EAS system at) a broadcasting station (Emergency Alert System at Station). At (the EAS system at) the broadcasting station, rendering, encoding, or conversion into a predetermined format are performed on the CAP information received from the alerting sources, and the resulting information is provided to a local broadcasting station (Local Broadcast) or the CAP information is provided to the broadcasting station (Local Broadcast) without format change. Then, (a transmitter of) the local broadcasting station transmits the emergency information transmitted as described above to a plurality of receivers in a broadcasting area.

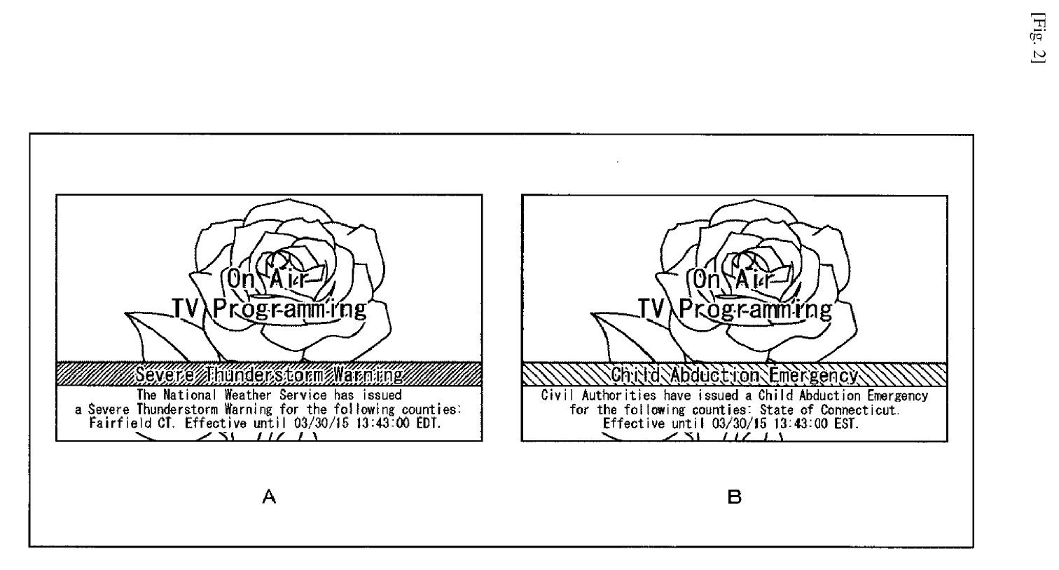

For example, the alerting source corresponds to a national organization (for example, the National Weather Service (NWS)) providing meteorological services, and provides a weather warning. In this case, the broadcasting station and the receiver that has received the emergency information from (the transmitter of) the broadcasting station display the weather warning superimposed on a broadcast program (FIG. 2A). Further, for example, when the alerting source corresponds to a regional organization or the like, the alerting source provides alerting source information related to the region. In this case, the broadcasting station and the receiver that has received the emergency information from (the transmitter of) the broadcasting station display the emergency information related to the region superimposed on the broadcast program (FIG. 2B).

Here, at the broadcasting station, when vocal emergency information is generated from the CAP information using the TTS engine, there is a problem in that it is difficult to guarantee clear and correct pronunciation which is demanded by the regulations of the FCC. In other words, in the TTS engine, there is no guarantee that the visually handicapped will be able to obtain the same information as others because text information may not be read out loud according to the intentions of an emergency information producer.

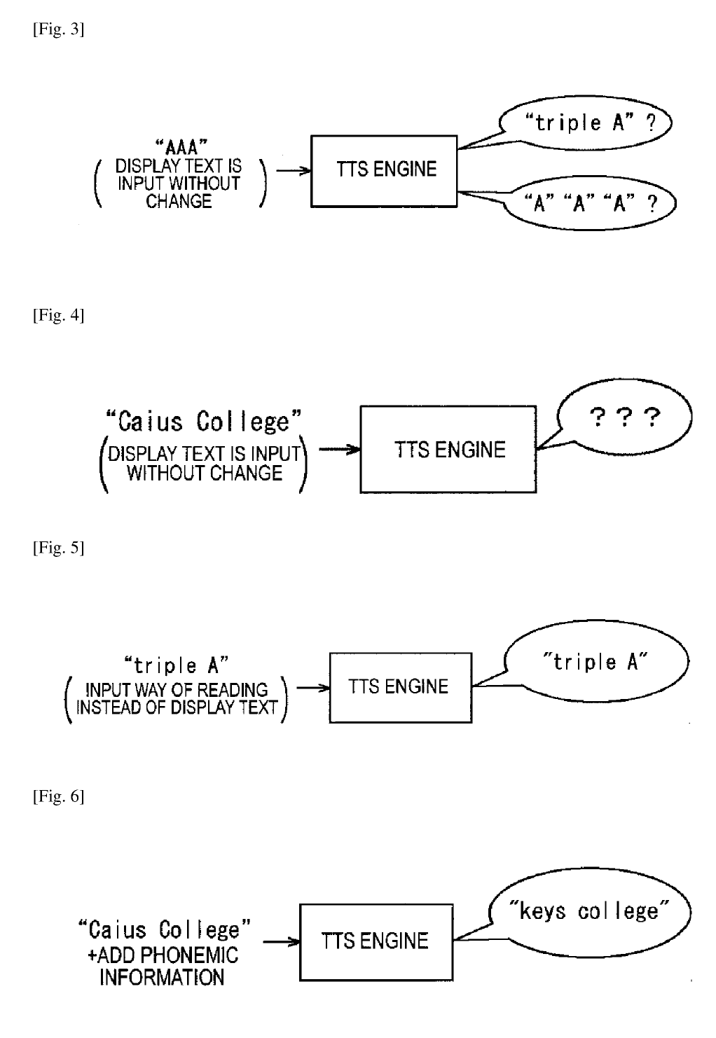

Specifically, as illustrated in FIG. 3, for example, since text information of “AAA” can be read as “triple A” or “A A A,” and the way of reading it is not uniquely decided, it is difficult for the TTS engine to determine how to read it, and thus there is a chance that the text information will not be read as intended by a producer.

Further, as illustrated in FIG. 4, for example, since text information of “Caius College” is a proper noun whose pronunciation is difficult, etc., it is difficult for the TTS engine to determine how to read it, and thus there is a chance that the text information will not be read as intended by a producer.

As described above, when a there is no uniquely decided way of reading text information (a message of the emergency information) or when text information is a proper noun whose pronunciation is difficult, etc., there is a chance that the text information will not be read as intended by a producer, and thus there has been a demand for a technique that allows the visually handicapped to obtain the same information as others by reliably producing an utterance as intended by a producer.

In this regard, in an embodiment of the present technology, in order to cause emergency information to be reliably uttered through voice as intended by a producer, information (hereinafter referred to as “vocal utterance metadata”) related to the vocal utterance intended by the producer is provided to the TTS engine, and the TTS engine produces the vocal utterance intended by the producer. The vocal utterance metadata may be provided as part of the CAP information.

Specifically, as illustrated in FIG. 5, for example, “triple A” indicating a way of reading the text information of “AAA” through voice is provided to the TTS engine as the vocal utterance metadata, and thus the TTS engine can read “triple A” based on the vocal utterance metadata.

In other words, in FIG. 3, when the text information of “AAA” is input, it is difficult for the TTS engine to determine which of “triple A” and “A A A” is the correct reading, but in FIG. 5, as “triple A” is input as the vocal utterance metadata, the TTS engine can read it as “triple A” according to the vocal utterance metadata. As a result, the vocal utterance intended by the producer is produced.

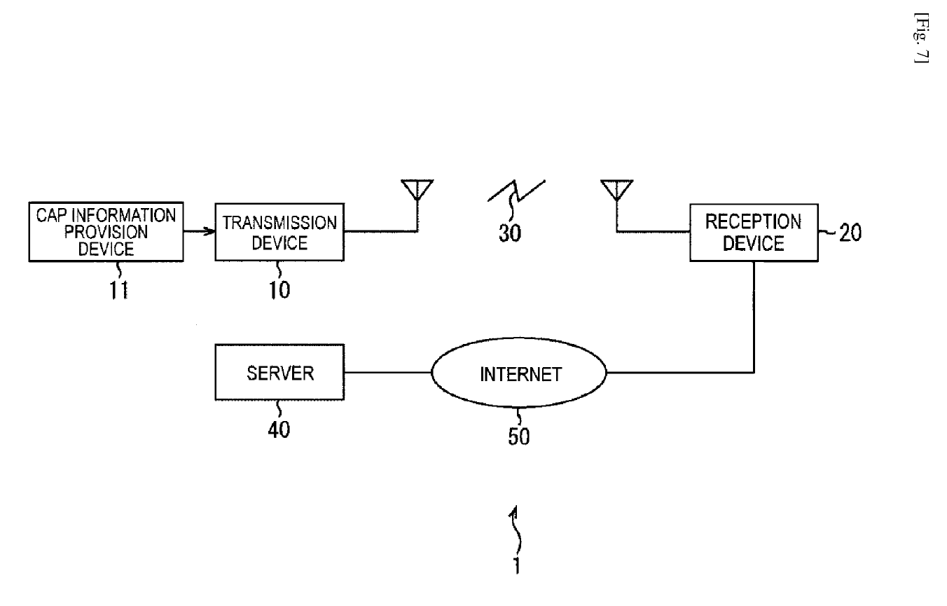

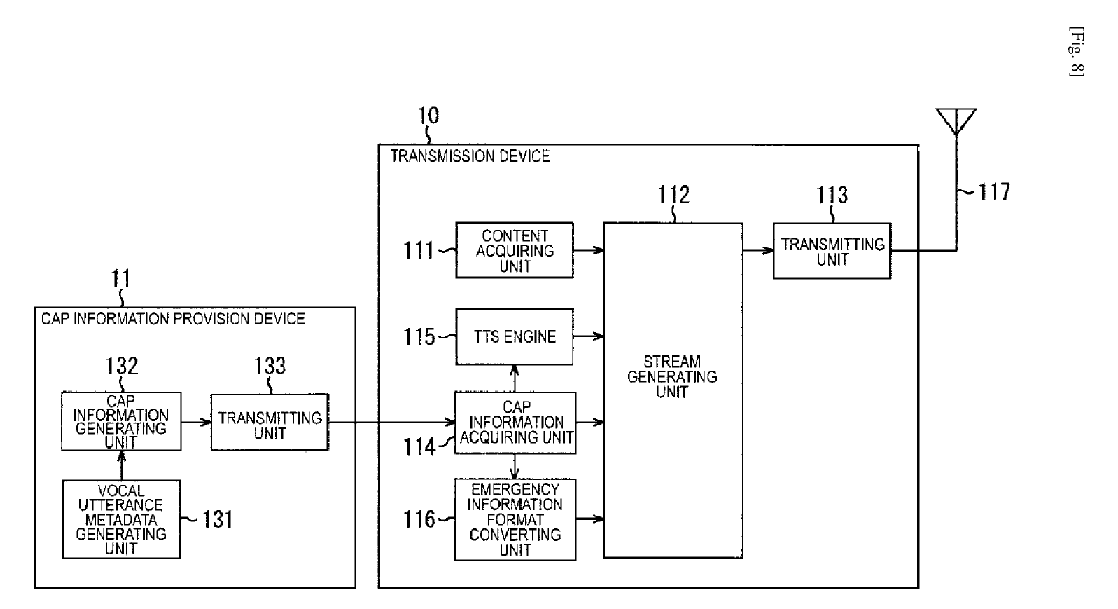

Further, as illustrated in FIG. 6, for example, phonemic information of the text information of “Caius College” is provided to the TTS engine as the vocal utterance metadata, and thus the TTS engine can read “keys college” based on the vocal utterance metadata.

In other words, in FIG. 4, when the text information of “Caius College” is input, since the text information is a proper noun whose pronunciation is difficult, etc., it is difficult for the TTS engine to determine how to read it correctly, but in FIG. 6, as the phonemic information is input as the vocal utterance metadata, the TTS engine can read it as “keys college” according to the vocal utterance metadata. As a result, the vocal utterance intended by the producer is produced.

As described above, as the vocal utterance metadata is provided to the TTS engine, for example, even when there is no uniquely decided way of reading text information (an message of the emergency information) or when it is a proper noun whose pronunciation is difficult, etc., the text information is read as intended by the producer, and thus the visually handicapped can obtain the same information as others.

### 2. Configuration of System

Configuration Example of Broadcasting System

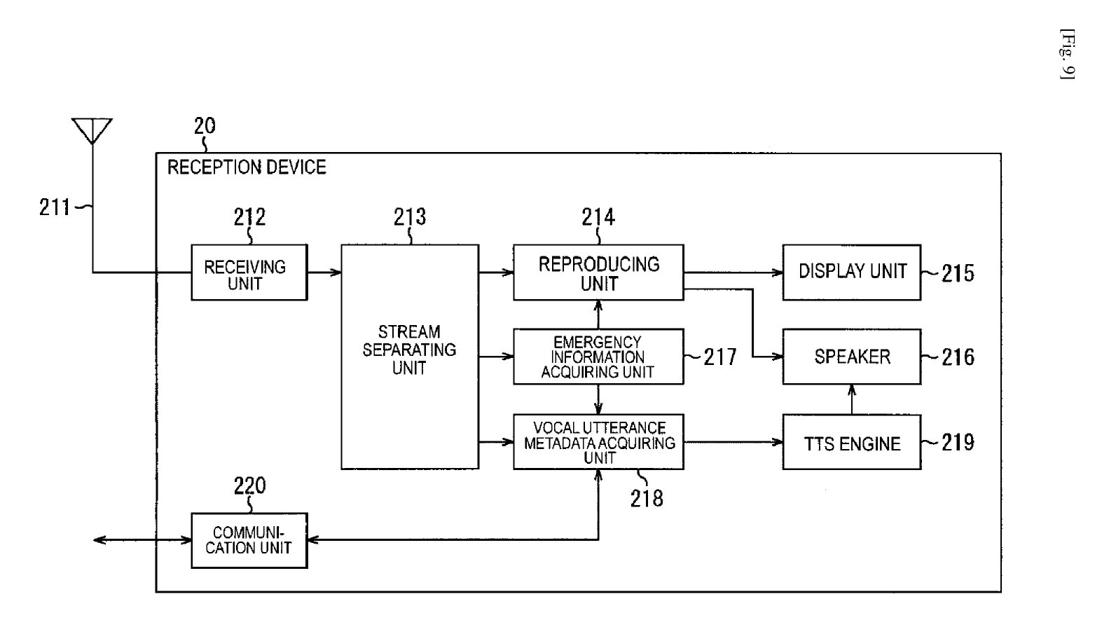

FIG. 7 is a diagram illustrating a configuration example of a broadcasting system to which an embodiment of the present technology is applied.

Referring to FIG. 7, a broadcasting system 1 is a system that provides content such as broadcast programs and allows the visually handicapped to access emergency information serving as information of which notification is urgent. The broadcasting system 1 includes a transmission device 10 and a CAP information provision device 11 that are arranged at a transmission side and a reception device 20 at a reception side. The reception device 20 can communicate with a server 40 via the Internet 50.

For example, the transmission device 10 is run by a broadcasting station that provides a digital terrestrial broadcasting service. The transmission device 10 transmits content such as broadcast programs through a digital broadcasting signal. The transmission device 10 corresponds to the broadcasting station (Station) and the local broadcasting station (Local Broadcast) of FIG. 1.

In an emergency, the CAP information provision device 11 generates CAP information (hereinafter, also referred to as “extended CAP information”) including the vocal utterance metadata, and transmits the extended CAP information to the transmission device 10. The extended CAP information generated by the CAP information provision device 11 corresponds to the CAP information from the alerting sources (Alerting Sources) of FIG. 1.

In an emergency, the transmission device 10 receives the extended CAP information transmitted from the CAP information provision device 11, includes emergency information of a predetermined data format based on the extended CAP information in a digital broadcasting signal, and transmits the resulting digital broadcasting signal. Here, in order to comply with the regulations of the FCC, it is necessary to transmit vocal information of the message in order to allow the visually handicapped to access the message (text information) of the emergency information. In this regard, in an embodiment of the present technology, the following three schemes are proposed as a scheme of transmitting the vocal information of the message of the emergency information.

In a first scheme, a process such as rendering or encoding for causing the message included in the extended CAP information to be displayed on a screen of the reception device 20 as a video is performed on the message included in the extended CAP information, and the resulting information is transmitted as the emergency information. At this time, a process such as decoding for generating vocal information of the message transmitted as the emergency information is performed on the extended CAP information, and the obtained vocal information is transmitted as the emergency information. In other words, in the first scheme, vocal information (information related to voice) is transmitted as the emergency information together with the message.

In this case, the TTS engine of the transmission device 10 at the transmission side reads the message according to the vocal utterance metadata included in the extended CAP information, and thus the text information is reliably read as intended by the producer, for example, even when there is no uniquely decided way of reading the text information or when the text information is a proper noun whose pronunciation is difficult.

In a second scheme, the extended CAP information is converted into a format complying with a predetermined format specified by the Advanced Television Systems Committee (ATSC) serving as a digital broadcasting standard of the USA, and information (hereinafter referred to as “ATSC signaling information”) corresponding to the regulations of the ATSC obtained in this way is transmitted as the emergency information. Here, for example, a format specified in ATSC 3.0 serving as a next generation digital broadcasting standard of the USA may be employed. In other words, in the second scheme, the ATSC signaling information including the message and the vocal utterance metadata (information related to voice) is transmitted as the emergency information.

In a third scheme, the extended CAP information is transmitted as the emergency information without format change. In other words, in the third scheme, the extended CAP information including the message and the vocal utterance metadata (the information related to voice) is transmitted as the emergency information.

For example, the reception device 20 is configured with a television receiver, a set top box, a video recorder, or the like, and installed in houses of users or the like. The reception device 20 receives the digital broadcasting signal transmitted from the transmission device 10 via a transmission path 30, and outputs video and audio of content such as broadcast programs.

In an emergency, when the emergency information transmitted from the transmission device 10 is received, the reception device 20 displays the message of the emergency information. In this case, the emergency information transmitted from the transmission device 10 is transmitted through any one of the first to third schemes.

In the first scheme, since the vocal information of the message superimposed on the video is transmitted, the reception device 20 outputs sound corresponding to the vocal information. In this case, in the transmission device 10 at the transmission side, since the TTS engine reads the vocal information according to the vocal utterance metadata, the message superimposed on the video is read as intended by the producer.

In the second scheme, since the ATSC signaling information obtained by converting the extended CAP information is transmitted, the reception device 20 can read the message included in the ATSC signaling information which is being displayed according to the vocal utterance metadata included in the ATSC signaling information. Further, in the third scheme, since the extended CAP information is transmitted, the reception device 20 can read the message included in the extended CAP information which is being displayed according to the vocal utterance metadata included in the extended CAP information.

Here, in the second scheme and the third scheme, the TTS engine of the reception device 20 at the reception side reads the message of the emergency information according to the vocal utterance metadata, and thus the text information is read as intended by the producer, for example, even when there is no uniquely decided way of reading the text information or when the text information is a proper noun whose pronunciation is difficult.

Further, as the vocal utterance metadata stored in the ATSC signaling information or the extended CAP information, there are two types, that is, metadata describing address information for acquiring the vocal utterance metadata and metadata describing content of the vocal utterance metadata. Further, when the address information is included in the vocal utterance metadata, content of the vocal utterance metadata is described in a file (hereinafter referred to as a “vocal utterance metadata file”) acquired according to the address information.

As the address information, for example, a Uniform Resource Locator (URL) for accessing the server 40 on the Internet 50 is designated. Here, the server 40 manages the vocal utterance metadata file. The reception device 20 can access the server 40 via the Internet 50 according to the address information (for example, a URL) described in the vocal utterance metadata included in the ATSC signaling information or the extended CAP information and acquire the vocal utterance metadata file.

The first to third schemes are examples of a data format for transmitting the vocal information of the message transmitted as the emergency information, and any other data format may be employed. Further, when the first scheme or the second scheme is employed, information of each local broadcasting station may be generated based on regional information such as geographical data as the emergency information.

In the broadcasting system 1 of FIG. 7, only one transmission device 10 is illustrated, but in practice, the transmission device 10 is installed for each of a plurality of broadcasting stations, and each of the transmission devices 10 acquires the extended CAP information supplied from the CAP information provision device 11. Similarly, in the broadcasting system 1 of FIG. 7, only one reception device 20 is illustrated, but in practice, the reception device 20 is installed for each house of a plurality of users.

(Configuration Example of Transmission Side)

FIG. 8 is a diagram illustrating a configuration example of the transmission device 10 and the CAP information provision device 11 at the transmission side of FIG. 7.

Referring to FIG. 8, the transmission device 10 includes a content acquiring unit 111, a stream generating unit 112, a transmitting unit 113, a CAP information acquiring unit 114, a TTS engine 115, and an emergency information format converting unit 116.

The content acquiring unit 111 acquires content such as broadcast programs, and supplies the acquired content to the stream generating unit 112. The content acquiring unit 111 can execute, for example, encoding, a format conversion process, or the like on the content.

Further, for example, the content acquiring unit 111 acquires corresponding content from a storage location of already recorded content according to a broadcasting time zone or acquires live content from a studio or site.

The stream generating unit 112 generates a stream complying with the regulations of the ATSC by multiplexing signaling data or the like into the content data supplied from the content acquiring unit 111, and supplies the generated stream to the transmitting unit 113.

The transmitting unit 113 performs, for example, a process such as digital modulation on the stream supplied from the stream generating unit 112, and transmits the resulting stream through an antenna 117 as a digital broadcasting signal.

Here, in an emergency, the extended CAP information supplied from the CAP information provision device 11 is transmitted to the transmission device 10. Referring to FIG. 8, the CAP information provision device 11 includes a vocal utterance metadata generating unit 131, a CAP information generating unit 132, and a transmitting unit 133.

In an emergency, the vocal utterance metadata generating unit 131 generates the vocal utterance metadata, for example, according to instructions from the emergency information producer, and supplies the vocal utterance metadata to the CAP information generating unit 132. As the vocal utterance metadata, for example, information indicating how to read the text information through voice when there is no uniquely decided way of reading the text information or phonemic information of the text information when the text information is a proper noun whose pronunciation is difficult or the like is generated.

In an emergency, the CAP information generating unit 132 generates the extended CAP information based on the alerting source information transmitted from the alerting source, and supplies the extended CAP information to the transmitting unit 133. Here, for example, the CAP information generating unit 132 generates the extended CAP information by storing (arranging) the vocal utterance metadata supplied from the vocal utterance metadata generating unit 131 in the CAP information including the message of the emergency information. The transmitting unit 133 transmits the extended CAP information including the vocal utterance metadata to the transmission device 10.

In the transmission device 10, in an emergency, the CAP information acquiring unit 114 acquires (receives) the extended CAP information transmitted from the CAP information provision device 11. The CAP information acquiring unit 114 supplies the extended CAP information to the stream generating unit 112, the TTS engine 115, or the emergency information format converting unit 116.

Here, as described above, in order to comply with the regulations of the FCC, it is necessary to transmit the vocal information of the message of the emergency information using any one of the first to third schemes.

Specifically, when the first scheme is employed, the extended CAP information supplied from the CAP information acquiring unit 114 is supplied to the stream generating unit 112 and the TTS engine 115. The TTS engine 115 supplies the vocal information (the information related to voice) obtained by decoding (reading) the message included in the extended CAP information based on the vocal utterance metadata included in the extended CAP information to the stream generating unit 112 as the emergency information. In this case, since the TTS engine 115 reads the text information according to the vocal utterance metadata, the text information is reliably read as intended by the producer.

Then, the stream generating unit 112 generates a stream complying with the regulations of the ATSC by further multiplexing the vocal information supplied from the TTS engine 115 into the stream including content data of the video on which the message included in the extended CAP information supplied from the CAP information acquiring unit 114 is superimposed.

Further, when the second scheme is employed, the extended CAP information supplied from the CAP information acquiring unit 114 is supplied to the emergency information format converting unit 116. The emergency information format converting unit 116 converts the extended CAP information into a format complying with a predetermined format specified by the ATSC (for example, ATSC3.0), and supplies the ATSC signaling information including the message and the vocal utterance metadata (the information related to voice) obtained in this way to the stream generating unit 112 as the emergency information. Then, the stream generating unit 112 generates the stream complying with the regulations of the ATSC by multiplexing the emergency information supplied from the emergency information format converting unit 116 together with the content data, the signaling data, or the like.

Further, when the third scheme is employed, the extended CAP information (the extended CAP information including the message and the vocal utterance metadata (the information related to voice)) supplied from the CAP information acquiring unit 114 is supplied to the stream generating unit 112 as the emergency information without format change. Then, the stream generating unit 112 generates the stream complying with the regulations of the ATSC by multiplexing the emergency information supplied from the CAP information acquiring unit 114 together with the content data, the signaling data, or the like.

In an emergency, the transmitting unit 113 transmits the stream including the emergency information supplied from the stream generating unit 112 through the antenna 117 as the digital broadcasting signal.

The transmission device 10 of FIG. 8 corresponds to the broadcasting station (Station) and the local broadcasting station (Local Broadcast) of FIG. 1, but, for example, the process related to the emergency information is the process performed at the broadcasting station side of FIG. 1, and the process of transmitting the digital broadcasting signal to the reception device 20 is the process performed at the local broadcasting station side of FIG. 1. However, content of the present technology is not limited by whether or not the process performed by the transmission device 10 of FIG. 8 is performed at the broadcasting station side of FIG. 1 or the local broadcasting station side.

Further, in the transmission device 10 and the CAP information provision device 11 of FIG. 8, all functional blocks need not be arranged in a single device, and at least some functional blocks may be configured as devices independent of the other functional blocks. For example, the vocal utterance metadata generating unit 131 or the CAP information generating unit 132 may be provided as a function of a server (for example, the server 40) on the Internet 50. In this case, the transmission device 10 or the CAP information provision device 11 acquires and processes the vocal utterance metadata or the CAP information (the extended CAP information) provided from the server.

(Configuration Example of Reception Side)

FIG. 9 is a diagram illustrating a configuration example of the reception device 20 at the reception side of FIG. 7.

Referring to FIG. 9, the reception device 20 includes a receiving unit 212, a stream separating unit 213, a reproducing unit 214, a display unit 215, a speaker 216, an emergency information acquiring unit 217, a vocal utterance metadata acquiring unit 218, a TTS engine 219, and a communication unit 220.

The receiving unit 212 performs, for example, a modulation process on the digital broadcasting signal received by an antenna 211, and supplies a stream obtained in this way to the stream separating unit 213. The stream separating unit 213 separates the signaling data and the content data from the stream supplied from the receiving unit 212, and supplies the signaling data and the content data to the reproducing unit 214.

The reproducing unit 214 causes the video of the content data supplied from the stream separating unit 213 to be displayed on the display unit 215, and outputs the audio of the content data through the speaker 216 based on the signaling data separated by the stream separating unit 213. As a result, the content such as a broadcast program is reproduced.

Further, in an emergency, the stream separating unit 213 separates, for example, the content data and the extended CAP information from the stream supplied from the receiving unit 212, and supplies the content data and the extended CAP information to the reproducing unit 214 and the emergency information acquiring unit 217, respectively. Here, in an emergency, the process corresponding to one of the first to third schemes employed at the transmission side is performed.

Specifically, when the first scheme is employed, since the message of the emergency information is superimposed on the video of the content data included in the stream separated by the stream separating unit 213, the reproducing unit 214 causes (subtitles of) the message to be displayed on the display unit 215. Further, since the vocal information (the information related to voice) of the message of the emergency information is included in the stream separated by the stream separating unit 213, the reproducing unit 214 outputs the sound corresponding to the vocal information through the speaker 216.

Further, since the vocal information is the information obtained by the TTS engine 115 decoding (reading) the message according the vocal utterance metadata included in the extended CAP information in the transmission device 10 at the transmission side, (the subtitles of) the message displayed on the display unit 215 are read as intended by the producer.

Further, when the second scheme is employed, the emergency information acquiring unit 217 acquires the emergency information (the ATSC signaling information) separated by the stream separating unit 213. The emergency information acquiring unit 217 processes the ATSC signaling information, and supplies the message of the emergency information to the reproducing unit 214. The reproducing unit 214 causes (the subtitles of) the message supplied from the emergency information acquiring unit 217 to be displayed on the display unit 215.

The emergency information acquiring unit 217 supplies the vocal utterance metadata included in the ATSC signaling information to the vocal utterance metadata acquiring unit 218. The vocal utterance metadata acquiring unit 218 acquires and processes the vocal utterance metadata supplied from the emergency information acquiring unit 217.

Here, as described above, as the vocal utterance metadata, there are two types, that is, metadata describing address information for acquiring the vocal utterance metadata and metadata describing content of the vocal utterance metadata.

In other words, when the vocal utterance metadata includes content thereof, the vocal utterance metadata acquiring unit 218 supplies the vocal utterance metadata to the TTS engine 219 without change. On the other hand, when the address information is included in the vocal utterance metadata, the vocal utterance metadata acquiring unit 218 controls the communication unit 220, accesses the server 40 via the Internet 50 according to the address information (for example, the URL), and acquires the vocal utterance metadata file. The vocal utterance metadata acquiring unit 218 supplies the vocal utterance metadata including content obtained from the vocal utterance metadata file to the TTS engine 219.

The TTS engine 219 reads the message included in the ATSC signaling information based on the vocal utterance metadata supplied from the vocal utterance metadata acquiring unit 218, and outputs the sound thereof through the speaker 216. The sound is the sound that corresponds to (the subtitles of) the message being displayed on the display unit 215 and is read by the TTS engine 219 according to the vocal utterance metadata, and thus the message is read through voice as intended by the producer.

Further, when the third scheme is employed, the emergency information acquiring unit 217 acquires the emergency information (the extended CAP information) separated by the stream separating unit 213. The emergency information acquiring unit 217 processes the extended CAP information, and supplies the message of the emergency information to the reproducing unit 214. The reproducing unit 214 causes (the subtitles of) the message supplied from the emergency information acquiring unit 217 to be displayed on the display unit 215.

The emergency information acquiring unit 217 supplies the vocal utterance metadata included in the extended CAP information to the vocal utterance metadata acquiring unit 218. The vocal utterance metadata acquiring unit 218 acquires and processes the vocal utterance metadata supplied from the emergency information acquiring unit 217.

When the vocal utterance metadata includes content thereof, the vocal utterance metadata acquiring unit 218 supplies the vocal utterance metadata to the TTS engine 219 without change. On the other hand, when the vocal utterance metadata includes the address information (for example, the URL), the vocal utterance metadata acquiring unit 218 controls the communication unit 220, acquires the vocal utterance metadata file from the server 40 on the Internet 50, and supplies the vocal utterance metadata including content obtained in this way to the TTS engine 219.

The TTS engine 219 reads the message included in the extended CAP information based on the vocal utterance metadata supplied from the vocal utterance metadata acquiring unit 218, and outputs the sound thereof through the speaker 216. The sound is the sound that corresponds to (the subtitles of) the message being displayed on the display unit 215 and is read by the TTS engine 219 according to the vocal utterance metadata, and thus the message is read through voice as intended by the producer.

For example, in the second scheme and the third scheme, when (the subtitles of) the message of the emergency information of FIG. 2A, FIG. 2B, or the like is being displayed on the display unit 215, in order to allow the visually handicapped to access the message, the TTS engine 219 causes the text information to be read as intended by the producer according to the vocal utterance metadata when there is no uniquely decided way of reading the text information when the message is read. As a result, the visually handicapped can obtain the same information as others.

The display unit 215 and the speaker 216 are arranged in the reception device 20 of

FIG. 9, but, for example, when the reception device 20 is a set top box, a video recorder, or the like, the display unit 215 and the speaker 216 may be arranged as separate external devices.

### 3. Arrangement of the Vocal Utterance Metadata by Extension of the CAP Information

(Structure of CAP)

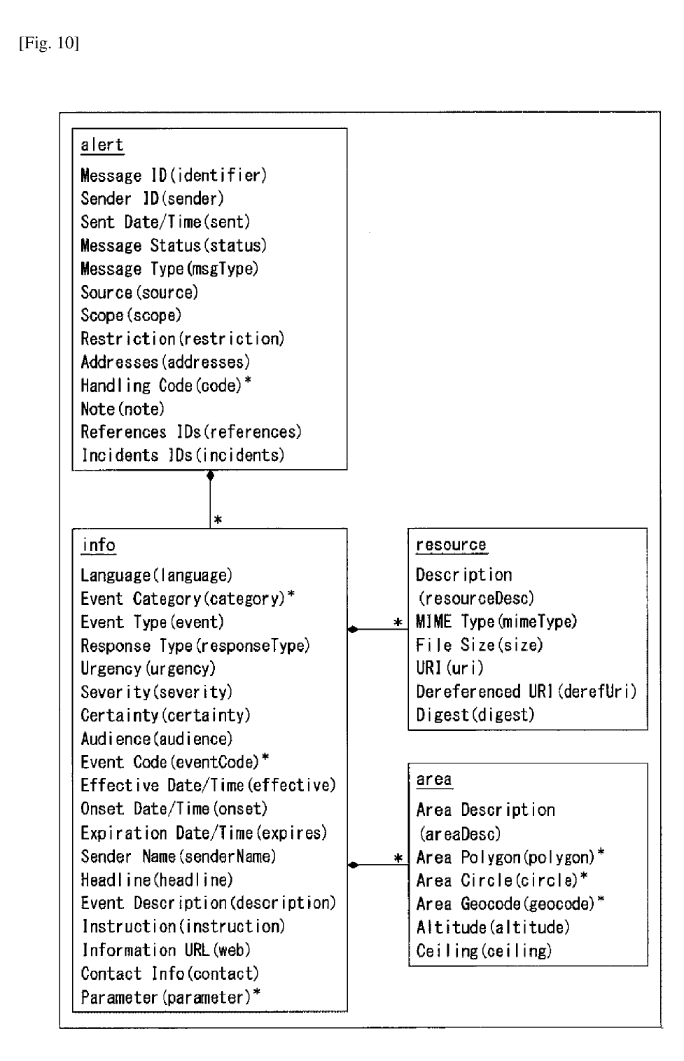

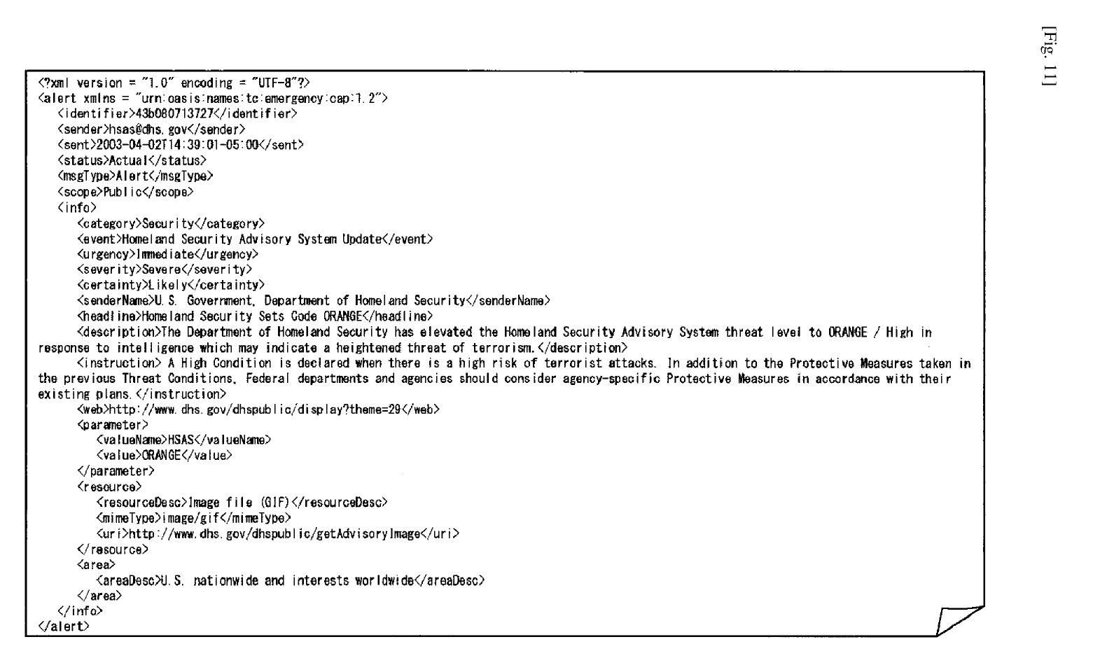

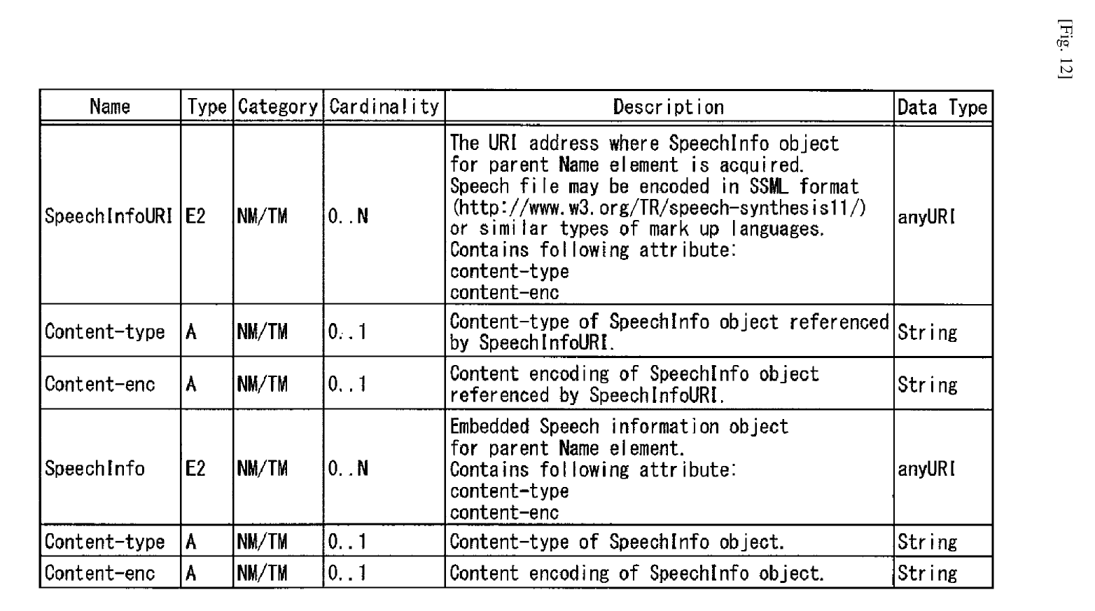

FIG. 10 is a diagram illustrating an example of a structure of the CAP information. The CAP information is information specified by the OASIS. The CAP information is an example of alerting source information.

As illustrated in FIG. 10, the CAP information is configured with an alert segment, an info segment, a resource segment, and an area segment. One or more info segments may be included in the alert segment. It is arbitrary whether or not the resource segment and the area segment are included in the info segment.

In the alert segment, an alert element includes an identifier element, a sender element, a sent element, a status element, an msgType element, a source element, a scope element, a restriction element, an addresses element, a code element, a note element, a references element, and an incidents element as child elements.

Basic information related to the CAP information is described in the alert element. In other words, the alert element functions as a container of all components configuring the CAP information. The alert element is regarded as a necessary element.

An ID identifying the CAP information is designated in the identifier element. An ID identifying a provider of the CAP information is designated in the sender element. A provision date and time of the CAP information are designated in the sent element. A code indicating handling of the CAP information is designated in the status element. As the code of the status element, “Actual,” “Exercise,” “System,” “Test,” or “Draft” is designated.

A code indicating a type of the CAP information is designated in the msgType element. As the code of the msgType element, “Alert,” “Update,” “Cancel,” “Ack,” or “Error” is designated. Information indicating a source of the CAP information is designated in the source element. A code indicating a scope of the CAP information is designated in the scope element. As the code of the scope element, “Public,” “Restricted,” or “Private” is designated.

A restriction for restricting the distribution of the restricted CAP information is designated in the restriction element. A list of groups of users who receive the CAP information is designated in the addresses element. A code indicating a special process of the CAP information is designated in the code element. Information describing the purpose or the significance of the CAP information is designated in the note element. Information related to a message of a reference destination of the CAP information is designated in the references element. Information related to a naming rule of the CAP information is designated in the incidents element.

In the info segment, an info element includes a language element, a category element, an event element, a responseType element, an urgency element, a severity element, a certainty element, an audience element, an eventCode element, an effective element, an onset element, an expires element, a senderName element, a headline element, a description element, an instruction element, a web element, a contact element, and a parameter element as child elements.

Substantive information related to the CAP information is described in the info element. In other words, the info element functions as a container of all components (the child elements) configuring the info element of the CAP information. The info element is regarded as an optional element, but at least one info element is included in most of the alert elements.

A code indicating a language of a sub element of the CAP information is designated in the language element. A code specified in RFC 3066 is referred to as the language code. A code indicating a category of the CAP information is designated in the category element. As the code of the category element, “Geo (Geophysical),” “Met (Meteorological),” “Safety,” “Security,” “Rescue,” “Fire,” “Health,” “Env (Pollution and other environmental),” “Transport (Public and private transportation),” “Infra (Utility, telecommunication, other non-transport infrastructure),” “CBRNE (Chemical, Biological, Radiological, Nuclear or High-Yield Explosive threat or attack),” or “Other” is designated.

Information indicating a type of an event of the CAP information is designated in the event element. A code indicating an action recommended to the user is designated in the responseType element. As the code of the responseType element, “Shelter,” “Evacuate,” “Prepare,” “Execute,” “Avoid,” “Monitor,” “Assess,” “All Clear,” or “None” is designated. A code indicating a degree of urgency of the CAP information is designated in the urgency element. As the code of the urgency element, “Immediate,” “Expected,” “Future,” “Past,” or “Unknown” is designated.

A code indicating a degree of severity of the CAP information is designated in the severity element. As the code of the severity element, “Extreme,” “Severe,” “Moderate,” “Minor,” or “Unknown” is designated. A code indicating certainty of the CAP information is designated in the certainty element. As the code of the certainty element, “Observed,” “Likely,” “Possible,” “Unlikely,” or “Unknown” is designated.

Information describing the user serving as the target of the CAP information is designated in the audience element. A system-specific identifier identifying a type of an event of the CAP information is designated in the eventCode element. Information indicating an effective period of time of content of the CAP information is designated in the effective element. Information indicating a scheduled start time of an event of the CAP information is designated in the onset element. Information indicating an expiration date of content of the CAP information is designated in the expires element.

Information (text information) indicating a name of the provider of the CAP information is designated in the senderName element. Information (text information) indicating a headline of content of the CAP information is designated in the headline element. Information (text information) indicating the details of content of the CAP information is designated in the description element. Information (text information) indicating an action to be taken by (an action to be recommended to) the user who has checked the CAP information is designated in the instruction element.

A URL indicating an acquisition destination of additional information of the CAP information is designated in the web element. Information indicating a follow-up or check contact of the CAP information is designated in the contact element. An additional parameter associated with the CAP information is designated in the parameter element.

In the resource segment, a resource element includes a resourceDesc element, a mimeType element, a size element, a uri element, a derefUri element, and a digest element as child elements.

The resource element provides resource files such as image or video files as additional information associated with information described in the info element. In other words, the resource element functions as a container of all components (the child elements) configuring the resource element of the CAP information. The resource element is regarded as an optional element.

Information (text information) indicating a type and content of the resource file is designated in the resourceDesc element. A MIME type of the resource file is designated in the mimeType element. A type specified in RFC 2046 is referred to as the MIME type.

A value indicating the size of the resource file is designated in the size element. A uniform resource identifier (URI) of an acquisition destination of the resource file is designated in the uri element. Information related to the resource file encoded by Base 64 is designated in the derefUri element. A code indicating a hash value demanded in the resource file is designated in the digest element.

In the area segment, an area element includes an areaDesc element, a polygon element, a circle element, a geocode element, an altitude element, and a ceiling element as child elements.

The area element provides information related to a geographical range associated with the information described in the info element. In other words, the area element functions as a container of all components (the child elements) configuring the area element of the CAP information. The area element is regarded as an optional element.

Information related to a region that is influenced by the CAP information is designated in the areaDesc element. Information defining the region that is influenced by the CAP information through a polygon is designated in the polygon element. Information defining the region that is influenced by the CAP information through a radius is designated in the circle element. Information defining the region that is influenced by the CAP information through a regional code (position information) is designated in the geocode element.

Information indicating a specific altitude or a lowest altitude of the region that is influenced by the CAP information is designated in the altitude element. Information indicating a highest altitude of the region that is influenced by the CAP information is designated in the ceiling element.

(Description Example of CAP Information)

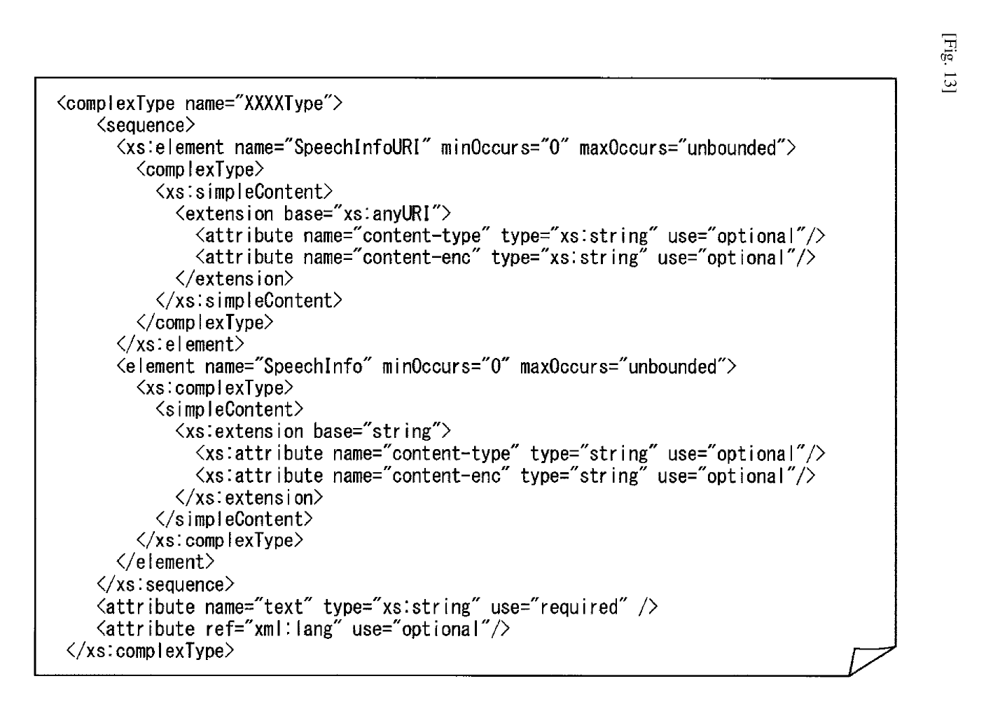

Here, FIG. 11 illustrates a description example of the CAP information described as an Extensible Markup Language (XML) document. In the info element in the alert element of FIG. 11, a name of a provider of the CAP information is described in the senderName element, a headline of content of the CAP information is described in the headline element, and the details of content of the CAP information are described in the description element. Further, information indicating an action to be taken by (an action to be recommended to) the user who has checked the CAP information is described in the instruction element of the info element in the alert element.

Here, in the reception device 20, when the text information is displayed, it is necessary to read the text information through the TTS engine in order to allow the visually handicapped to access the text information, but, for example, as described above, there is a chance of the text information not being read as intended by the producer when there is no uniquely decided way of reading the text information or when the text information is a proper noun whose pronunciation is difficult or the like.

Further, in an embodiment of the present technology, the vocal utterance metadata is provided to the TTS engine so that the text information is read as intended by the producer, but the vocal utterance metadata is stored (arranged) in the extended CAP information. Next, a detailed configuration of the CAP information (the extended CAP information) in which the vocal utterance metadata is arranged will be described.

(Configuration Example of Extended CAP Information)

FIG. 12 is a diagram illustrating examples of elements and attributes added in the extended CAP information to store the vocal utterance metadata or the address information indicating the acquisition destination thereof. The elements and the attributes added in the extended CAP information in FIG. 12 are, for example, elements such as the senderName element, the headline element, the description element, and the instruction element of the info element.

In other words, in the extended CAP information, an extension of adding a SpeechInfoURI element or a SpeechInfo element as the child element of the senderName element, the headline element, the description element, or the instruction element is performed.

An address information for acquiring the vocal utterance metadata is designated in the SpeechInfoURI element. For example, a URI is designated as the address information. Further, for example, when the vocal utterance metadata file is acquired from the server 40 on the Internet 50, a URL for accessing the server 40 is designated as the address information.

The vocal utterance metadata may be described in a Speech Synthesis Markup Language (SSML). The SSML is recommended by the World Wide Web Consortium (W3C) for the purpose of enabling use of a high-quality speech synthesis function. Using the SSML, it is possible to control elements necessary for speech synthesis such as pronunciation, volume, or tone sensitively and adequately.

A Content-type attribute and a Content-enc attribute are used as a pair with the SpeechInfoURI element. Type information indicating a type of the vocal utterance metadata acquired by referring to the address information such as the URI is designated in the Content-type attribute. Further, information indicating an encoding scheme of the vocal utterance metadata acquired by referring to the address information is designated in the Content-enc attribute.

Content of the vocal utterance metadata is described in the SpeechInfo element. For example, content of the vocal utterance metadata is described in the SSML. Further, the Content-type attribute and the Content-enc attribute used as a pair can be designated in the SpeechInfo element as well. Type information indicating a type of the vocal utterance metadata described in the SpeechInfo element is designated in the Content-type attribute. Further, information indicating an encoding scheme of the vocal utterance metadata described in the SpeechInfo element is designated in the Content-enc attribute.

In FIG. 12, when “0 . . . N” is designated as the cardinality, it is arbitrary whether or not the element or the attribute is designated one or more times. Further, when “0 . . . 1” is designated, it is arbitrary whether or not the element or the attribute is designated. Thus, the SpeechInfoURI element and the SpeechInfo element are optional elements, and the SpeechInfoURI element and the SpeechInfo element may be arranged in one of the elements or in both of the elements. Further, it is arbitrary whether or not the Content-type attribute and the Content-enc attribute attached to the SpeechInfoURI element and the SpeechInfo element are arranged.

(Description Example of XML Schema)

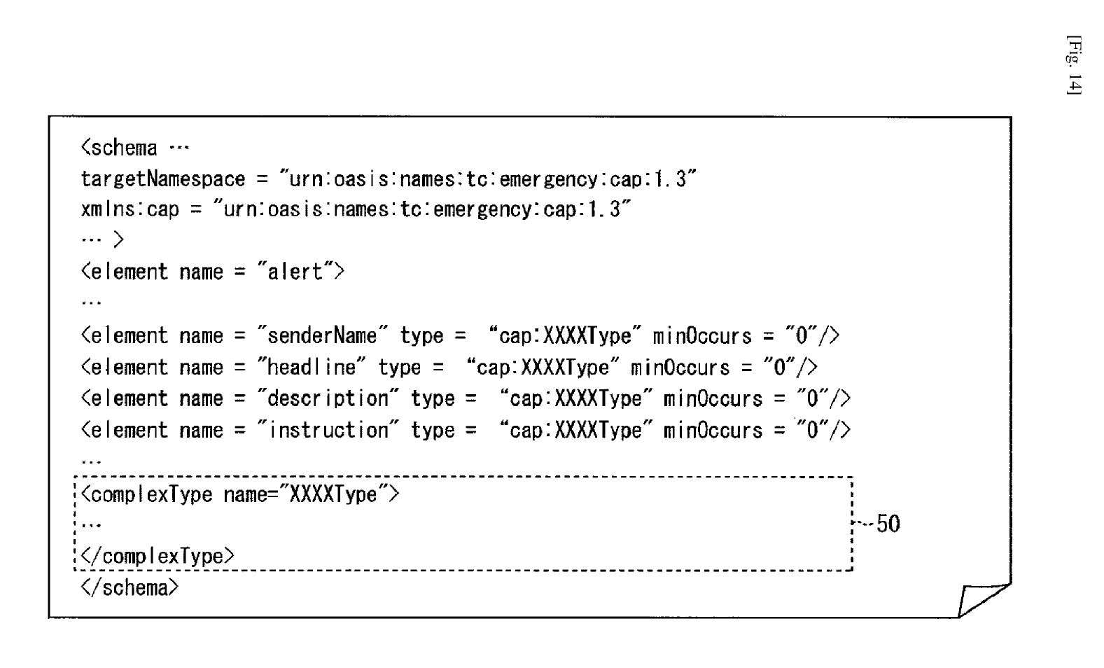

FIG. 13 is a diagram illustrating a description example of an XML schema (an XML schema of the CAP) defining a structure of the extended CAP information serving as an XML document (an XML instance).

Referring to FIG. 13, type definition of an element is performed by a ComplexType element. In other words, “XXXXType” is defined as a type for designating a child element and an attribute to be added to content of an xsd:sequence element (content between a start tag and an end tag).

In a name attribute of an xs:element element in a third line, “SpeechInfoURI” is designated, and the SpeechInfoURI element is declared. The SpeechInfoURI element declares that a minimum cardinality is “0” through a minOccurs attribute, and declares that a maximum cardinality is not limited through a maxOccurs attribute.

“content-type” is designated in a name attribute of an attribute element in a seventh line, and the Content-type attribute is declared as an attribute of the SpeechInfoURI element. The Content-type attribute declares that it is a character string type (String) through a type attribute, and declares that it is an optional attribute through a use attribute.

“content-enc” is designated in a name attribute of an attribute element in a eighth line, and the Content-enc attribute is declared as an attribute of the SpeechInfoURI element. The Content-enc attribute declares that it is a character string type (String) through a type attribute, and declares that it is an optional attribute through a use attribute.

In a name attribute of an xs:element element in a thirteenth line, “SpeechInfo” is designated, and the SpeechInfo element is declared. The SpeechInfo element declares that a minimum cardinality is “0” through a minOccurs attribute, and declares that a maximum cardinality is not limited through a maxOccurs attribute.

“content-type” is designated in a name attribute of an attribute element in a seventeenth line, and the Content-type attribute of the SpeechInfo element is declared. The Content-type attribute declares that it is a character string type (String) through a type attribute, and declares that it is an optional attribute through a use attribute.

“content-enc” is designated in a name attribute of an attribute element in a eighteenth line, and the Content-enc attribute of the SpeechInfo element is declared. The Contentenc attribute declares that it is a character string type (String) through a type attribute, and declares that it is an optional attribute through a use attribute.

(Designation of Name Space of XML Schema)

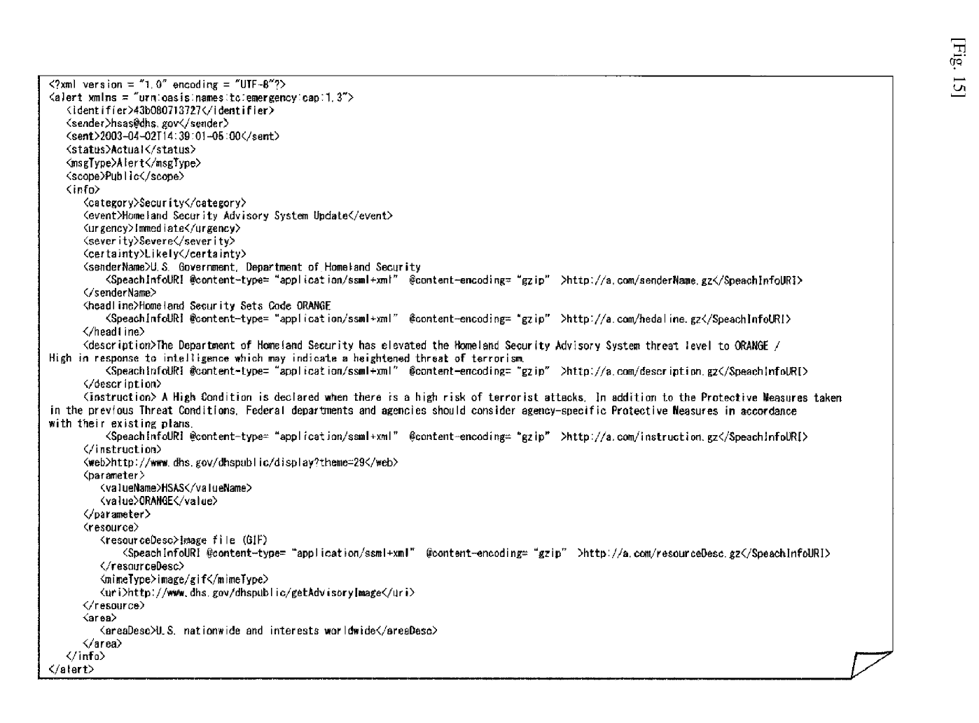

A designation of a name space of an XML schema may be described as in an XML schema of FIG. 14. In the XML schema of FIG. 14, the content of the ComplexType element of FIG. 13 (the content between the start tag and the end tag) is described in a region 50 describing a type of an element defined by the ComplexType element.

In FIG. 14, it is designated by a targetNamespace attribute of a schema element that the XML schema defines a structure of the extended CAP information. Here, when the name space (Namespace) of the current CAP information (the non-extended CAP information) is indicated by “urn:oasis:names:tc:emergency:cap:1.2,” the name space of the extended CAP information proposed by an embodiment of the present technology is defined by “urn:oasis:names:tc:emergency:cap:1.3.” Further, it is declared by “xmlns:cap” that a name space prefix of the XML schema used as the extended CAP information is “cap.”

Further, in FIG. 14, the elements such as the alert element, the info element, the resource element, and area element are declared by an element element. Further, in the element element, the senderName element, the headline element, the description element, and the instruction element are declared.

Here, “cap:XXXXType” is designated in the senderName element as the type attribute, which means that content of an element, an attribute, or the like attached to the senderName element is designated by a type of “XXXXType” defined by the ComplexType element of the XML schema.

In the XML schema of FIG. 14, since content of the ComplexType element of FIG. 13 is described in the region 50 describing the type of the element defined by the ComplexType element, the SpeechInfoURI element or the SpeechInfo element can be designated in the senderName element as the child element thereof. Further, the Content-type attribute and the Content-enc attribute can be designated in the SpeechInfoURI element and the SpeechInfo element. Further, a minOccurs attribute of the element element indicates that the minimum cardinality of the senderName element is “0.”

Similarly, the SpeechInfoURI element or the SpeechInfo element can be designated in the headline element, the description element, and the instruction element as the child element thereof according to the type of “XXXXType” defined by the ComplexType element of the XML schema. Further, the Content-type attribute and the Content-enc attribute can be designated in the SpeechInfoURI element and the SpeechInfo element.

By defining the XML schema as described above and, for example, by changing a name space designated by an xmlns attribute of an alert element in a second line from “urn:oasis:names:tc:emergency:cap:1.2” to “urn:oasis:names:tc:emergency:cap:1.3” in the description example of the CAP information illustrated in FIG. 11, it is possible to use “XXXXType” defined by the XML schema (the XML schema of the CAP) of FIG. 14. In this case, in the senderName element, the headline element, the description element, and the instruction element, it is possible to designate the SpeechInfoURI element or the SpeechInfo element, and the CAP information is extended to the extended CAP information. A description example of the extended CAP information is illustrated in FIG. 15.

As the SpeechInfoURI element or the SpeechInfo element is designated as the child elements of the senderName element, the headline element, the description element, and the instruction element of the info element as described above, it is possible to set the vocal utterance metadata serving as information related to the vocal utterance intended by the producer as the element to which the text information is designated.

Thus, in an emergency, at the reception device 20, for example, when a viewable message (text information) such as information indicating the name of the provider of the emergency information, the headline of content of the emergency information, the details of content of the emergency information, or an action to be taken by the user which is obtained by processing the extended CAP information is displayed, the message (the text information) is read according to the vocal utterance metadata as intended by the producer. As a result, the visually handicapped can obtain the same information as others, and thus accessibility for the visually handicapped can be improved.

In the above description, the senderName element, the headline element, the description element, and the instruction element of the info element have been described as the elements to which the SpeechInfoURI element or the SpeechInfo element can be designated, but an element or an attribute to which a message (text information) is designated such as the resourceDesc element in the extended CAP information may be regarded as the target in which the message (the text information) of the element or the attribute is read.

### 4. Flow of Process Executed by Devices

Next, the flow of a process performed by the transmission device 10 and the reception device 20 configuring the broadcasting system 1 of FIG. 7 will be described.

(Transmission Process)

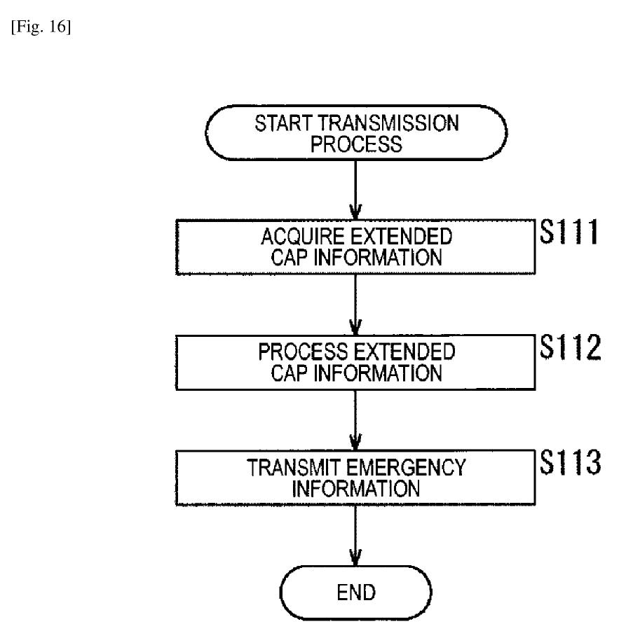

First, the flow of a transmission process performed by the transmission device 10 of FIG. 7 will be described with reference to a flowchart of FIG. 16. The transmission process of FIG. 16 is a process performed when the transmission device 10 receives the extended CAP information supplied from the CAP information provision device 11 in an emergency.

In step S111, the CAP information acquiring unit 114 acquires (receives) the extended CAP information transmitted from the CAP information provision device 11.

In step S112, the extended CAP information acquired in the process of step S111 is processed according to any one of the first to third schemes.

Specifically, when the first scheme is employed, the TTS engine 115 supplies vocal information (information related to voice) obtained by decoding (reading) the message included in the extended CAP information based on the vocal utterance metadata included in the extended CAP information acquired in the process of step S111 to the stream generating unit 112 as the emergency information. The stream generating unit 112 generates the stream complying with the regulations of the ATSC by further multiplexing the vocal information supplied from the TTS engine 115 into the stream including the content data of the video on which the message included in the extended CAP information is superimposed.

Further, when the second scheme is employed, the emergency information format converting unit 116 converts the extended CAP information acquired in the process of step S111 into a predetermined format specified by the ATSC, and supplies the ATSC signaling information including the message and the vocal utterance metadata (the information related to voice) obtained in this way to the stream generating unit 112 as the emergency information. The stream generating unit 112 generates the stream complying with the regulations of the ATSC by multiplexing the emergency information supplied from the emergency information format converting unit 116 together with the content data, the signaling data, or the like.

Further, when the third scheme is employed, the CAP information acquiring unit 114 supplies the extended CAP information (the extended CAP information including the message and the vocal utterance metadata (the information related to voice)) acquired in the process of step S111 to the stream generating unit 112 as the emergency information without format change. The stream generating unit 112 generates the stream complying with the regulations of the ATSC by multiplexing the emergency information supplied from the CAP information acquiring unit 114 together with the content data, the signaling data, or the like.

In step S113, the transmitting unit 113 transmits (the stream including) the emergency information obtained by processing the extended CAP information in the process of step S112 as the digital broadcasting signal through the antenna 117.

Further, when content thereof is not described in the vocal utterance metadata included in the extended CAP information acquired in the process of step S111, a URL for accessing the server 40 on the Internet 50 is described as the address information for acquiring the vocal utterance metadata file.

The flow of the transmission process in an emergency has been described above. In the transmission process, the ATSC signaling information including the vocal information according to the vocal utterance metadata related to the vocal utterance intended by the producer or the vocal utterance metadata which is included in the extended CAP information or the extended CAP information is transmitted as the emergency information.

Thus, the reception device 20 at the reception side outputs the sound corresponding to the vocal information according to the vocal utterance metadata or reads the message according to the vocal utterance metadata, and thus, for example, even when there is no uniquely decided way of reading the message of the emergency information or when the text information is a proper noun whose pronunciation is difficult or the like, the text information is reliably read as intended by the producer. As a result, the visually handicapped obtain the same information (emergency information) as others.

(Reception Process)

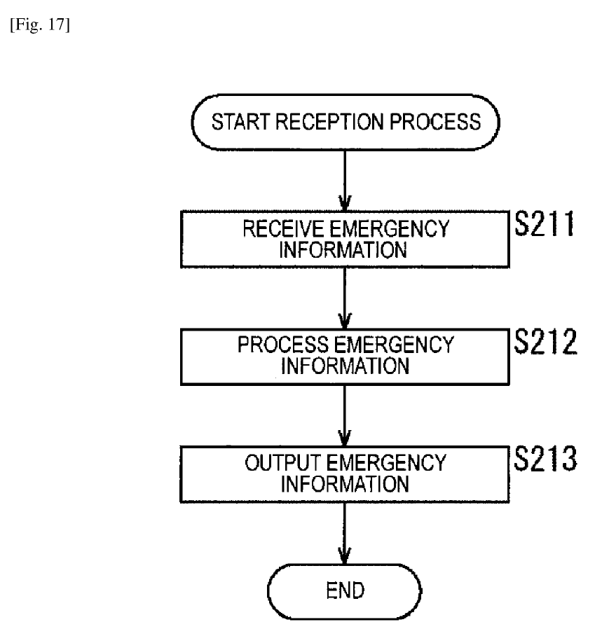

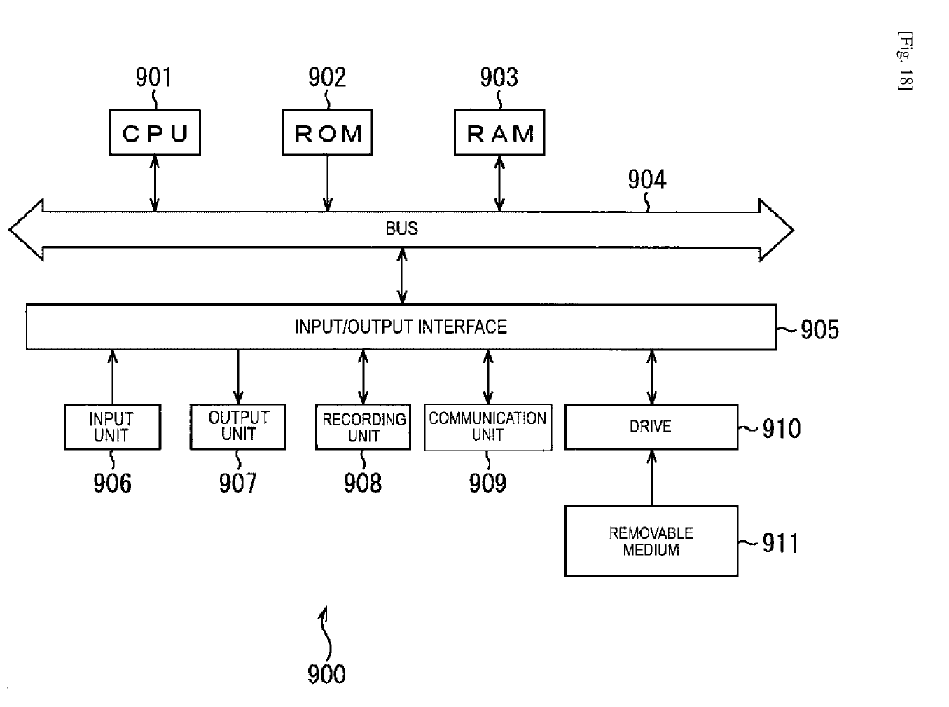

Next, the flow of a reception process performed by the reception device 20 of FIG. 7 will be described with reference to a flowchart of FIG. 17. The reception process of FIG. 17 is a process performed when an emergency occurs while content such as a broadcast program selected by a user is being reproduced, and the emergency information transmitted from the transmission device 10 is received.

In step S211, in an emergency, the emergency information acquiring unit 217 receives (acquires) the emergency information supplied from the stream separating unit 213.

In step S212, the emergency information acquired in the process of step S211 is processed according to one of the first to third schemes employed at the transmission side. In step S213, the emergency information is output according to the processing result of the emergency information in the process of step S212.

Specifically, when the first scheme is employed, since the message of the emergency information is superimposed, as the emergency information, on the video of the content data included in the stream separated by the stream separating unit 213, the reproducing unit 214 causes (subtitles of) the message to be displayed on the display unit 215 (S212, S213). Further, since the vocal information (the information related to voice) of the message of the emergency information is included in the stream separated by the stream separating unit 213, the reproducing unit 214 outputs the sound corresponding to the vocal information through the speaker 216 (S212, S213).

Further, when the second scheme is employed, since the ATSC signaling information is acquired as the emergency information, the emergency information acquiring unit 217 processes the ATSC signaling information, and supplies the message of the emergency information to the reproducing unit 214. The reproducing unit 214 causes (the subtitles of) the message of the emergency information supplied from the emergency information acquiring unit 217 to be displayed on the display unit 215 (S212 and S213).

Meanwhile, the emergency information acquiring unit 217 supplies the vocal utterance metadata included in the ATSC signaling information to the vocal utterance metadata acquiring unit 218. The vocal utterance metadata acquiring unit 218 acquires and processes the vocal utterance metadata supplied from the emergency information acquiring unit 217 (S212). Then, the TTS engine 219 reads the message included in the ATSC signaling information based on the vocal utterance metadata supplied from the vocal utterance metadata acquiring unit 218, and outputs the sound thereof through the speaker 216 (S213).

Further, when the third scheme is employed, since the extended CAP information is acquired as the emergency information, the emergency information acquiring unit 217 processes the extended CAP information, and supplies the message of the emergency information to the reproducing unit 214. The reproducing unit 214 causes (the subtitles of) the message of the emergency information supplied from the emergency information acquiring unit 217 to be displayed on the display unit 215 (S212 and S213).

Meanwhile, the emergency information acquiring unit 217 supplies the vocal utterance metadata included in the extended CAP information to the vocal utterance metadata acquiring unit 218. The vocal utterance metadata acquiring unit 218 acquires and processes the vocal utterance metadata supplied from the emergency information acquiring unit 217 (S212). Then, the TTS engine 219 reads the message included in the extended CAP information based on the vocal utterance metadata supplied from the vocal utterance metadata acquiring unit 218, and outputs the sound thereof through the speaker 216 (S213).

Further, in the second scheme and the third scheme, when content is not described in the vocal utterance metadata included in the emergency information (the ATSC signaling information or the extended CAP information) acquired in the process of step S211, the address information for acquiring the vocal utterance metadata file is described. In this case, the vocal utterance metadata acquiring unit 218 controls the communication unit 220, accesses the server 40 via the Internet 50 according to the address information (for example, the URL), acquires the vocal utterance metadata file, and supplies the vocal utterance metadata including the content obtained in this way to the TTS engine 219.

The flow of the reception process in an emergency has been described above. In the reception process, the ATSC signaling information including the vocal information according to the vocal utterance metadata related to the vocal utterance intended by the producer or the vocal utterance metadata or the extended CAP information which is transmitted from the transmission device 10 at the transmission side is received as the emergency information.

Thus, the reception device 20 outputs the sound corresponding to the vocal information according to the vocal utterance metadata or reads the message according to the vocal utterance metadata, and thus, for example, even when there is no uniquely decided way of reading the message of the emergency information or when the text information is a proper noun whose pronunciation is difficult or the like, the text information is reliably read as intended by the producer. As a result, the visually handicapped obtain the same information (emergency information) as others.

### 5. Modified Example

In the above description, the ATSC (for example, ATSC3.0) that is employed in the USA and the like has been described as the digital television broadcasting standard, but the present technology can be applied to Integrated Services Digital Broadcasting (ISDB) employed in Japan and the like, Digital Video Broadcasting (DVB) employed in some European countries, or the like. The transmission path 30 (FIG. 7) is not limited to digital terrestrial television broadcasting and may be employed in digital satellite television broadcasting, digital cable television broadcasting, or the like.

Further, in the above description, the extended CAP information has been described as being generated by the CAP information provision device 11, but the present technology is not limited to the CAP information provision device 11, and, for example, the transmission device 10, the server 40, or the like may generate the extended CAP information based on the alerting source information transmitted from the alerting source. Further, when the extended CAP information is processed in the transmission device 10 at the transmission side, if the address information for acquiring the vocal utterance metadata file is described in the vocal utterance metadata, the transmission device 10 may access the server 40 via the Internet 50 according to the address information (for example, the URL) and acquire the vocal utterance metadata file.

Further, in the above description, the information of the CAP scheme applied in the USA is transmitted as the alerting source information, but the present technology is not limited to the information of the CAP scheme, and alerting source information of any other format may be used. For example, accessibility for the visually handicapped is assumed to be demanded in Japan and European countries, and in such cases, alerting source information of another format suitable for the corresponding country can be used rather than the CAP information (the extended CAP information).

Further, in the above description, when the address information (for example, the URL) is included in the vocal utterance metadata, the vocal utterance metadata file is acquired from the server 40 on the Internet 50, but the vocal utterance metadata file may be included in the digital broadcasting signal and then transmitted. In other words, the vocal utterance metadata file is delivered via broadcasting or communication and received by the reception device 20. Here, when the vocal utterance metadata file is delivered via broadcasting, for example, the vocal utterance metadata file may be transmitted through a Real-time Object Delivery over Unidirectional Transport (ROUTE) session. The ROUTE is a protocol extended from File Delivery over Unidirectional Transport (FLUTE) serving as a protocol suitable for transmitting binary files in one direction in a multicast manner.

Further, in the above description, the vocal utterance metadata is described in the SSML, but the present technology is not limited to the SSML, and the vocal utterance metadata may be described in any other mark-up language. Here, when the vocal utterance metadata is described in the SSML, the element such as the sub element, the phoneme element, or the audio element and the attribute specified in the SSML may be used. The details of the SSML recommended by the W3C are found at the following web site:

Speech Synthesis Markup Language (the SSML) Version 1.1, W3C Recommendation 7 Sep. 2010, URL: “http://www.w3.org/TR/speech-synthesis111”

Further, in the above description, the reception device 20 has been described as being a fixed receiver such as the television receiver, the set top box, or the video recorder, but the reception device 20 is not limited to the fixed receiver and may be, for example, a mobile receiver such as a smartphone, a mobile telephone, a tablet type computer, a laptop personal computer, or a terminal used in a vehicle.

### 6. Configuration of Computer

The series of processes described above can be executed by hardware or can be executed by software. When the series of processes is executed by software, a program that constructs such software is installed in a computer. FIG. 18 is a diagram showing a configuration example of the hardware of a computer that executes the series of processes described above according to a program.

In a computer 900, a Central Processing Unit (CPU) 901, a Read Only Memory (ROM) 902, and a Random Access Memory (RAM) 903 are mutually connected by a bus 904. An input/output interface 905 is also connected to the bus 904. An input unit 906, an output unit 907, a recording unit 908, a communication unit 909, and a drive 910 are connected to the input/output interface 905.

The input unit 906 is configured as a keyboard, a mouse, a microphone or the like. The output unit 907 is configured as a display, a speaker or the like. The recording unit 908 is configured as a hard disk, a non-volatile memory or the like. The communication unit 909 is configured as a network interface or the like. The drive 910 drives a removable medium 911 such as a magnetic disk, an optical disc, a magneto-optical disc, a semiconductor memory or the like.

In the computer 900 configured as described above, the series of processes described earlier is performed such that the CPU 901 loads a program recorded in the ROM 902 or the recording unit 908 via the input/output interface 905 and the bus 904 into the RAM 903 and executes the program.

For example, the program executed by the computer 900 (the CPU 901) may be provided by being recorded on the removable medium 911 as a packaged medium or the like. The program can also be provided via a wired or wireless transfer medium, such as a local area network, the Internet, or digital satellite broadcasting.

In the computer 900, as the removable medium 911 is loaded into the drive 910, the program can be installed in the recording unit 908 via the input/output interface 905. It is also possible to receive the program from a wired or wireless transfer medium using the communication unit 909 and install the program in the recording unit 908. As another alternative, the program can be installed in advance in the ROM 902 or the recording unit 908.

Note that the processes performed by the computer according to the program need not be processes that are carried out in a time series in the order described in the flowcharts of this specification. In other words, the processes performed by the computer according to the program include processes that are carried out in parallel or individually (for example, parallel processes or processes by objects). Further, the program may be processed by a single computer (processor) or distributedly processed by a plurality of computers.

Embodiments of the present technology are not limited to the embodiments described above, and various changes can be made without departing from the gist of the present technology.

Additionally, the present technology may also be configured as below.

(1)

A transmission device, including:

circuitry configured to

receive alert information including metadata related to a predetermined pronunciation of a message;

generate vocal information for the message based on the metadata included in the alert information; and

transmit emergency information that includes the message and the generated vocal information for the message.

(2)

The transmission device according to (1),
wherein the metadata indicates the predetermined pronunciation of a character string which is readable in different ways or is spoken in a manner that differs from a way a word included in the character string is spelled.

(3)

The transmission device according to (1) or (2),
wherein the alert information includes the message, and
wherein a reception device that receives the emergency information displays the message, and outputs a sound according to the predetermined pronunciation of the message based on the vocal information.

(4)

The transmission device according to any of (1) to (3), wherein the circuitry is further configured to:
receive content,
transmit a digital broadcast signal that includes the content, and
transmit the emergency information.

(5)

The transmission device according to any of (1) to (4),
wherein the alert information is CAP information that is compliant with a Common Alerting Protocol (CAP) specified by the Organization for the Advancement of Structured Information Standards (OASIS), and
wherein the CAP information includes the metadata or address information indicating a location of a file of the metadata.

(6)

The transmission device according to (5),
wherein the vocal information, included in the emergency information, is generated by converting to speech the message included in the CAP information based on the metadata included in the CAP information.

(7)

The transmission device according to (5),
wherein the emergency information, including the message and the metadata, is generated by converting the CAP information into a format complying with a predetermined format specified by the Advanced Television Systems Committee (ATSC).

(8)

The transmission device according to (5),
wherein the emergency information is the CAP information including the message and the metadata.

(9)

A method of a transmission device for transmitting emergency information, the method including:
acquiring, by circuitry of the transmission device, alert information including metadata related to a predetermined pronunciation of a message;
generating, by the circuitry of the transmission device, vocal information for the message based on the metadata included in the alert information; and
transmitting, by the circuitry of the transmission device, the emergency information that includes the message and the generated vocal information for the message.

(10)

A reception device, including:
circuitry configured to
receive emergency information including a message and vocal information for the message, the emergency information being transmitted from a transmission device;
output the message for display, and
output a sound according to a predetermined pronunciation of the message based on the vocal information for the message.

(11)

The reception device according to (10),
wherein the emergency information is generated based on alert information including the message, and one of metadata related to the predetermined pronunciation of the message or reference to the metadata.

(12)

The reception device according to (10) or (11),
wherein the metadata indicates the predetermined pronunciation of a character string which is readable in different ways or is spoken in a manner that differs from a way a word included in the character string is spelled.

(13)

The reception device according to any of (10) to (12),
wherein the circuitry is configured to receive a digital broadcasting signal that includes content and is transmitted from the transmission device, and receive the emergency information.

(14)

The reception device according to any of (10) to (13),
wherein the alert information is CAP information that is compliant with a Common Alerting Protocol (CAP) specified by the Organization for the Advancement of Structured Information Standards (OASIS), and
wherein the CAP information includes the metadata or the reference to the metadata, the reference to the metadata being address information indicating a location of a file of the metadata or content of the metadata.

(15)

The reception device according to (14),
wherein the vocal information, included in the emergency information, is generated by converting to speech the message included in the CAP information based on the metadata included in the CAP information in the transmission device, and wherein the circuitry outputs a sound corresponding to the vocal information.

(16)

The reception device according to (14),
wherein the emergency information is generated by converting the CAP information into a format complying with a predetermined format specified by the Advanced Television Systems Committee (ATSC), and
wherein the circuitry is configured to convert to speech the message included in the emergency information based on the metadata included in the emergency information.

(17)

The reception device according to (14),
wherein the emergency information is the CAP information, and
wherein the circuitry is configured to convert to speech the message included in the CAP information based on the metadata included in the CAP information.

(18)

A method of a reception device for processing emergency information, the method including:
receiving, by circuitry of the reception device, emergency information including a message and vocal information for the message, the emergency information being transmitted from a transmission device;
outputting, by the circuitry of the reception device, the message for display; and
outputting, by the circuitry of the reception device, a sound according to a predetermined pronunciation of the message based on the vocal information for the message.

(19)

A transmission device, including:
an alerting source information acquiring unit configured to acquire alerting source information including metadata related to a vocal utterance intended by a producer of a message of emergency information of which notification is urgent in an emergency;
a processing unit configured to process the alerting source information; and
a transmitting unit configured to transmit vocal information of the message obtained by processing the alerting source information together with the message as the emergency information.

(20)

The transmission device according to (19),
wherein the metadata includes information related to an utterance of a character string for which there is no uniquely decided way of reading or a character string that is difficult to pronounce.

(21)

The transmission device according to (19) or (20),
wherein the alerting source information includes the message, and
wherein a reception device that receives the emergency information displays the message, and outputs a sound according to the vocal utterance intended by the producer of the message based on the vocal information of the message.

(22)

The transmission device according to any of (19) to (21), further including:
a content acquiring unit configured to acquire content,
wherein the transmitting unit transmits the content as a digital broadcasting signal, and transmits the emergency information when an emergency occurs.

(23)

The transmission device according to any of (19) to (22),
wherein the alerting source information is CAP information that is compliant with a Common Alerting Protocol (CAP) specified by the Organization for the Advancement of Structured Information Standards (OASIS), and
wherein the CAP information includes address information indicating an acquisition destination of a file of the metadata or content of the metadata.

(24)

The transmission device according to (23),
wherein the emergency information includes vocal information obtained by reading the message included in the CAP information based on the metadata included in the CAP information.

(25)

The transmission device according to (23),
wherein the emergency information is signaling information including the message and the metadata which is obtained by converting the CAP information into a format complying with a predetermined format specified by the Advanced Television Systems Committee (ATSC).

(26)

The transmission device according to (23),
wherein the emergency information is the CAP information including the message and the metadata.

(27)

A transmission method of a transmission device, including:
acquiring, by the transmission device, alerting source information including metadata related to a vocal utterance intended by a producer of a message of emergency information of which notification is urgent in an emergency;
processing, by the transmission device, the alerting source information; and
transmitting, by the transmission device, vocal information of the message obtained by processing the alerting source information together with the message as the emergency information.

(28)

A reception device, including:
a receiving unit configured to receive emergency information including a message of the emergency information of which notification is urgent and vocal information of the message, the emergency information being transmitted from a transmission device in an emergency; and
a processing unit configured to process the emergency information, display the message, and output a sound according to a vocal utterance intended by a producer of the message based on the vocal information of the message.

(29)

The reception device according to (28),
wherein the emergency information is obtained by processing alerting source information including the message and metadata related to the vocal utterance intended by the producer of the message.

(30)

The reception device according to (28) or (29),
wherein the metadata includes information related to an utterance of a character string for which there is no uniquely decided way of reading or a character string that is difficult to pronounce.

(31)

The reception device according to any of (28) to (30),
wherein the receiving unit receives content as a digital broadcasting signal transmitted from the transmission device, and receives the emergency information transmitted when an emergency occurs.

(32)

The reception device according to any of (28) to (31),
wherein the alerting source information is CAP information that is compliant with a Common Alerting Protocol (CAP) specified by the Organization for the Advancement of Structured Information Standards (OASIS), and
wherein the CAP information includes address information indicating an acquisition destination of a file of the metadata or content of the metadata.

(33)

The reception device according to (32),
wherein the emergency information includes vocal information obtained by reading the message included in the CAP information based on the metadata included in the CAP information in the transmission device, and
wherein the processing unit outputs a sound corresponding to the vocal information.

(34)

The reception device according to (32),
wherein the emergency information is signaling information obtained by converting the CAP information into a format complying with a predetermined format specified by the Advanced Television Systems Committee (ATSC), and
wherein the reception device further includes a voice reading unit configured to read the message included in the signaling information based on the metadata included in the signaling information.

(35)

The reception device according to (32),
wherein the emergency information is the CAP information, and
wherein the reception device further includes a voice reading unit configured to read the message included in the CAP information based on the metadata included in the CAP information.

(36)

A reception method of a reception device, including:
receiving, by the reception device, emergency information including a message of the emergency information of which notification is urgent and vocal information of the message, the emergency information being transmitted from a transmission device in an emergency; and
processing, by the reception device, the emergency information, displaying the message, and outputting a sound according to a vocal utterance intended by a producer of the message based on the vocal information of the message.

### REFERENCE SIGNS LIST

1 broadcasting system
10 transmission device
20 reception device
30 transmission path
40 server
50 Internet
111 content acquiring unit
112 stream generating unit
113 transmitting unit
114 CAP information acquiring unit
115 TTS engine
116 emergency information format converting unit
131 vocal utterance metadata generating unit
132 CAP information generating unit
133 transmitting unit
212 receiving unit
213 stream separating unit
214 reproducing unit
215 display unit
216 speaker
217 emergency information acquiring unit
218 vocal utterance metadata acquiring unit
219 TTS engine
220 communication unit
900 computer
901 CPU

1. A transmission device, comprising:
circuitry configured to
receive alert information including metadata related to a predetermined pronunciation of a message;
generate vocal information for the message based on the metadata included in the alert information; and
transmit emergency information that includes the message and the generated vocal information for the message.

2. The transmission device according to claim 1,
wherein the metadata indicates the predetermined pronunciation of a character string which is readable in different ways or is spoken in a manner that differs from a way a word included in the character string is spelled.

3. The transmission device according to claim 1,
wherein the alert information includes the message, and
wherein a reception device that receives the emergency information displays the message, and outputs a sound according to the predetermined pronunciation of the message based on the vocal information.

4. The transmission device according to claim 1, wherein the circuitry is further configured to:
receive content,
transmit a digital broadcast signal that includes the content, and
transmit the emergency information.

5. The transmission device according to claim 1,
wherein the alert information is CAP information that is compliant with a Common Alerting Protocol (CAP) specified by the Organization for the Advancement of Structured Information Standards (OASIS), and
wherein the CAP information includes the metadata or address information indicating a location of a file of the metadata.

6. The transmission device according to claim 5,
wherein the vocal information, included in the emergency information, is generated by converting to speech the message included in the CAP information based on the metadata included in the CAP information.

7. The transmission device according to claim 5,
wherein the emergency information, including the message and the metadata, is generated by converting the CAP information into a format complying with a predetermined format specified by the Advanced Television Systems Committee (ATSC).

8. The transmission device according to claim 5,
wherein the emergency information is the CAP information including the message and the metadata.

9. A method of a transmission device for transmitting emergency information, the method comprising:
acquiring, by circuitry of the transmission device, alert information including metadata related to a predetermined pronunciation of a message;
generating, by the circuitry of the transmission device, vocal information for the message based on the metadata included in the alert information; and
transmitting, by the circuitry of the transmission device, the emergency information that includes the message and the generated vocal information for the message.

10. A reception device, comprising:
circuitry configured to
receive emergency information including a message and vocal information for the message, the emergency information being transmitted from a transmission device;
output the message for display, and
output a sound according to a predetermined pronunciation of the message based on the vocal information for the message.

11. The reception device according to claim 10,
wherein the emergency information is generated based on alert information including the message, and one of metadata related to the predetermined pronunciation of the message or reference to the metadata.

12. The reception device according to claim 11,
wherein the metadata indicates the predetermined pronunciation of a character string which is readable in different ways or is spoken in a manner that differs from a way a word included in the character string is spelled.

13. The reception device according to claim 10,
wherein the circuitry is configured to receive a digital broadcasting signal that includes content and is transmitted from the transmission device, and receive the emergency information.

14. The reception device according to claim 11,
wherein the alert information is CAP information that is compliant with a Common Alerting Protocol (CAP) specified by the Organization for the Advancement of Structured Information Standards (OASIS), and
wherein the CAP information includes the metadata or the reference to the metadata, the reference to the metadata being address information indicating a location of a file of the metadata or content of the metadata.

15. The reception device according to claim 14,
wherein the vocal information, included in the emergency information, is generated by converting to speech the message included in the CAP information based on the metadata included in the CAP information in the transmission device, and
wherein the circuitry outputs a sound corresponding to the vocal information.

16. The reception device according to claim 14,
wherein the emergency information is generated by converting the CAP information into a format complying with a predetermined format specified by the Advanced Television Systems Committee (ATSC), and
wherein the circuitry is configured to convert to speech the message included in the emergency information based on the metadata included in the emergency information.

17. The reception device according to claim 14,
wherein the emergency information is the CAP information, and
wherein the circuitry is configured to convert to speech the message included in the CAP information based on the metadata included in the CAP information.

18. A method of a reception device for processing emergency information, the method comprising:
receiving, by circuitry of the reception device, emergency information including a message and vocal information for the message, the emergency information being transmitted from a transmission device;
outputting, by the circuitry of the reception device, the message for display; and
outputting, by the circuitry of the reception device, a sound according to a predetermined pronunciation of the message based on the vocal information for the message.
